(19) United States
(12) Patent Application Publication
(10) Pub. No.: US 2024/0312325 A1
(43) Pub. Date: Sep. 19, 2024

(54) SMOKE ALARM

(71) Applicant: EMERALD PLANET ENVIRONMENTAL PTY LTD, Frenchs Forest, New South Wales (AU)

(72) Inventors: Daniel Zamparelli, Frenchs Forest, New South Wales (AU); Faizan Zahoor, Frenchs Forest, New South Wales (AU)

(21) Appl. No.: 18/546,714

(22) PCT Filed: Feb. 17, 2022
(86) PCT No.: PCT/AU2022/050108

§ 371 Date: Aug. 16, 2023

(30) Foreign Application Priority Data
Feb. 18, 2021 (AU) 2021236433
Oct. 6, 2021 (AU) 2021245122
Oct. 19, 2021 (AU) 2021107584

(51) Int. Cl. G08B 17/113

(52) U.S. Cl. CPC G08B 17/113

(57) ABSTRACT

Disclosed herein is a smoke detector that includes: mains power connectivity (110) adapted to couple to a mains power supply; a long-life battery located in a sealed compartment (130); a microcontroller (150); a smoke detector (160) coupled to said microcontroller (150) so as to generate a trigger when said smoke detector (160) detects smoke; a power source selector (120) for selecting between mains power supply and said long-life battery (130) to power said microcontroller (150), based on the presence of said mains power supply; and a buzzer (140) for issuing an audible alert when said microcontroller (150) is triggered by said smoke detector (160) detecting the presence of smoke.

### RELATED APPLICATIONS

This application is related to Australian Patent Application No. 2021236433 titled “Smoke Alarm” and filed on 18 Feb. 2021 in the name of Emerald Planet Environmental Pty Ltd, Australian Patent Application No. 2021245122 titled “Smoke Alarm” and filed on 6 Oct. 2021 in the name of Emerald Planet Environmental Pty Ltd, and Australian Innovation Patent No. 2021107584 titled “Smoke Alarm” and filed on 19 Oct. 2021 in the name of Emerald Planet Environmental Pty Ltd, the entire content of each which is incorporated by reference as if fully set forth herein.

### TECHNICAL FIELD

The present disclosure relates to a smoke alarm. In particular, the present disclosure relates to a smoke alarm configured to operate with either one of two primary power sources.

### BACKGROUND

Smoke alarms are commonly installed in commercial and residential premises to provide occupants with a warning if the presence of smoke is detected. Smoke alarms include a detector for detecting the presence of smoke. Two commonly used detectors include ionization detectors and photoelectric detectors. Due to the deterioration of the active detecting elements, smoke alarms should be replaced after 10 years.

Existing smoke alarms have a single primary power source. Some smoke alarms are powered by battery powered. Battery powered smoke alarms can generally be installed by untrained persons and do not require an electrician. In some instances, consumer-level batteries are utilised, as consumer-level batteries are relatively cheap and are readily replaceable.

In many cases, battery powered smoke alarms utilise a 9V battery. The recommended lifespan of 9V batteries in smoke alarms is 6 months. This requires users to be vigilant about changing the batteries to ensure that the smoke alarms are functioning correctly. In order to enable consumer-level batteries to be changed, the batteries are located in a compartment of the smoke alarm that is easily opened by a user.

Many battery powered smoke alarms include circuitry configured to issue an audible warning when the battery level drops below a predefined threshold. These audible warnings can be quite annoying, as the warnings may trigger at any time, disrupting the overall peace and quiet. The warnings may potentially disrupt sleep, work, and the ability to converse, even if there is no imminent threat of danger. Further, changing batteries may require use of a ladder to access ceiling-mounted alarms and access to a ladder may not be readily available. As a consequence, the occupants must endure the audible warnings or vacate until the battery has been replaced.

If a replacement battery is not immediately available, it is common for people to remove the battery in order to stop the audible warnings. Unfortunately, removing the battery disables the alarm, thus putting any occupants at risk of a fire going undetected while the smoke alarm is disabled. It may take days, weeks, or longer for a replacement battery to be sourced. In the worst case scenario, the smoke alarm is forgotten and the battery is never replaced, endangering lives. Indeed, fatalities due to fire or smoke inhalation have occurred in houses equipped with smoke alarms for which the batteries have been removed and never replaced.

The 9V batteries typically utilised by battery powered smoke alarms may spend many months or even years on a retail shelf before being purchased. Over time, batteries lose performance due to current leakage and general degradation of the battery cell, even if the batteries remain in their original packaging and have never been used. Older batteries may result in shorter usable lifespans when operating battery powered smoke alarms. At best, this results in the inconvenience of having to replace the battery more frequently.

Older or defective batteries can also result in “false positives”, in which the smoke alarm issues an alarm, even though there is no smoke present. False positives can be incredibly frustrating, as occupants may vacate a building for no reason at any time of day or night, only to find that there was no threat. Smoke alarms that issue multiple false positives are often disregarded by occupants, delaying crucial responses when a real smoke threat is present. In some cases, users remove batteries from smoke alarms that issue false positives, removing protection for the occupants of the building and endangering the occupants in the case in which a real smoke or fire event eventuates.

An alternative form of battery powered smoke alarms utilises a long-life battery, such as a lithium battery. Such long-life batteries are typically rated to last 10 years and are sealed within the smoke alarms. Smoke alarms powered by sealed, long-life batteries are not able to be serviced by a user and the batteries are not replaceable.

In contrast, other smoke alarms are hardwired to a mains power supply. Most countries deliver mains power in the range of 220V to 240V. A smaller number of countries deliver mains power in the range of 100V to 127V. Mains power smoke alarms must be connected by a licensed electrician, to prevent the risk of electrocution. Mains power smoke alarms rely on a consistent source of power from an electricity supplier. As electricity supplies can be cut during storms and maintenance, resulting in a blackout, mains powered smoke alarms are often equipped with short-life battery backups designed to power the smoke alarm for short periods of time until the mains power is restored.

As there are both battery powered and mains powered smoke alarms, shops and installers typically need to carry both types of smoke alarms. This results in a larger inventory being carried.

Thus, a need exists to provide an improved smoke alarm.

### SUMMARY

The present disclosure relates to a smoke alarm with connectivity for dual primary power sources.

A first aspect of the present disclosure provides a smoke detector that includes:
mains power connectivity adapted to couple to a mains power supply;
a long-life battery located in a sealed compartment;
a microcontroller;
a smoke detector coupled to the microcontroller so as to generate a trigger when the smoke detector detects smoke;
a power source selector for selecting between mains power supply and the long-life battery to power the microcontroller, based on the presence of the mains power supply; and
a buzzer for issuing an audible alert when the microcontroller is triggered by the smoke detector detecting the presence of smoke.

In some embodiments, the smoke detector is at least one of an ionization smoke detector and a photoelectric smoke detector.

In some embodiments, the smoke alarm further includes:
a first light associated with the mains power connectivity; and
a second light associated with the long-life battery;
wherein the first light illuminates when the smoke detector is coupled to mains power, and
wherein the second light illuminates when the smoke detector is powered by the long-life battery and is not coupled to mains power.

In some embodiments, the first and second lights are light emitting diodes (LEDs).

In some embodiments, the first light and the second light are different colours.

In some embodiments, the first light illuminates in accordance with a predefined flash sequence. In some embodiments, the second light illuminates in accordance with a predefined flash sequence.

In some embodiments, the long-life battery is a lithium battery.

In some embodiments, the smoke detector further includes: a housing that defines a compartment within which the long-life battery is positioned, wherein the compartment is covered by a cover to form the sealed compartment. In some implementations, the cover is secured to the housing using at least one of: engaging clips, lugs, threads, fasteners, and adhesive.

In some embodiments, the power source selector includes a fixed voltage regulator that outputs: a higher voltage than the long-life battery when mains power is coupled to the mains power connectivity; and zero voltage when mains power is not coupled to the mains power connectivity.

In some embodiments, the power source selector further includes a reverse biased diode to prevent current flow from the long-life battery when mains power is coupled to the smoke detector.

In some embodiments, the smoke detector further includes: a radio frequency (RF) module coupled to the microcontroller, wherein the RF module is configured to transmit a wireless radiofrequency signal when the microcontroller is triggered by the smoke detector.

In some embodiments, the smoke detector further includes: connection circuitry for coupling the smoke detector to a remote smoke alarm, wherein the smoke detector sends an activation signal through the connection circuitry to the remote smoke alarm when the smoke detector generates a trigger upon detecting smoke.

In some embodiments, the microcontroller outputs a predefined buzzer frequency to the buzzer, when the microcontroller is triggered by the smoke detector.

In some embodiments, the smoke detector further includes: a third light that illuminates when the microcontroller is triggered by the smoke detector detecting the presence of smoke. In some implementations, the third light is a red LED that illuminates by flashing periodically in accordance with a predefined frequency.

Other aspects of the present disclosure are also provided.

### BRIEF DESCRIPTION OF THE DRAWINGS

One or more embodiments of the present disclosure will now be described by way of specific example(s) with reference to the accompanying drawings, in which:

FIG. 1 is a schematic block diagram representation of a smoke alarm with dual primary power sources;

FIG. 2 is a circuit diagram of one embodiment of a smoke alarm with dual primary power sources;

FIG. 3 is a pinout diagram of a microcontroller suitable for use in the circuit of FIG. 2;

FIG. 4 is a pinout diagram of a smoke detector suitable for use in the circuit of FIG. 2;

FIG. 5 is a circuit diagram of circuitry for illuminating different visual indicators of a smoke alarm with dual primary power sources;

FIG. 6 is a pinout diagram of an RF integrated circuit suitable for use with the circuit of FIG. 2 to implement the RF module 170 of FIG. 1;

FIG. 7 is a pinout diagram of a buzzer booster; and

FIG. 8 is a key for the circuit of FIG. 2.

Method steps or features in the accompanying drawings that have the same reference numerals are to be considered to have the same function(s) or operation(s), unless the contrary intention is expressed or implied.

### DETAILED DESCRIPTION

The present disclosure provides a smoke alarm with connectivity for dual primary power sources. The smoke alarm is equipped to receive power from either one of two primary power sources: (i) a mains power connection; and (ii) a sealed long-life battery, in order to power a smoke detector. The long-life battery is a battery suitable to provide power to the smoke alarm for 10 years, which is a standard lifespan for smoke alarms, due to the lifespan of the smoke detector. Providing a smoke alarm with two primary power sources enables the user to utilise the smoke alarm for the full 10 year (or more) lifespan of the smoke detector without having to change batteries or deal with low battery noises and false positives.

The smoke alarm includes a fixed voltage regulator that controls whether power is sourced from the long-life battery, when the smoke alarm is not connected to a mains power supply, or from the mains power supply, when the smoke alarm is connected to the mains power supply.

A smoke alarm equipped with connectivity for dual primary power sources, one of which is a sealed long-life battery, provides a single product that can be utilised in commercial and residential premises without the need to check or replace short-life commercial batteries.

Further, such a smoke alarm provides a safer environment, as the smoke alarm will continue to function for at least the lifespan of the long-life battery, irrespective of whether or not the smoke alarm is also connected to a mains power supply. In large environmental disasters, such as storms, cyclones, hurricanes, landslides, earthquakes, and the like, it is possible that mains power may be interrupted for days, weeks, months, or even years. In situations in which the smoke alarm is attached to a mains power supply and that power supply is interrupted, then the long-life battery ensures that power will continue to be supplied to the smoke alarm until the mains power supply is restored.

Further, by providing a smoke alarm that is capable of being activated as either a mains powered smoke alarm or a battery powered smoke alarm, it is only necessary for vendors and installers to stock a single type of smoke alarm.

In some embodiments, the smoke alarm includes a number of lights, such as light emitting diodes (LEDs) that illuminate to indicate which power source is operational. To aid with identification, the lights may be different colours such that a first light associated with the mains power is a different colour from a second light associated with the battery. In one implementation, the first light is a blue LED and the second light is a red LED. It will be appreciated that any colours may be utilised, depending on the application.

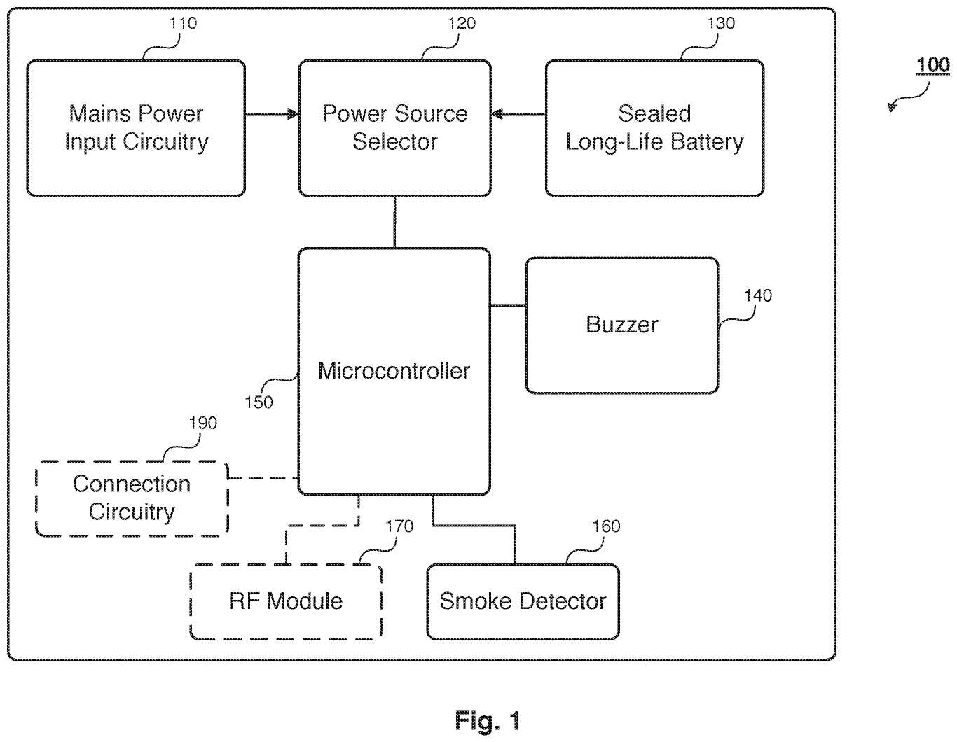

FIG. 1 is a schematic block diagram representation of a smoke alarm 100 with connectivity for dual primary power sources. The smoke alarm 100 includes Mains Power Input Circuitry 110 that provides a mains power interface for connecting the smoke alarm 100 to mains power. Mains power is typically alternating current (AC) in the range of 220V to 240V at a frequency between 50 Hz and 60 Hz. As noted above, a smaller number of countries deliver mains power in the range of 100V to 127V. The mains power interface may take different forms, depending on the application and local regulations. The mains power interface may be implemented, for example, using a plug to be inserted into a mains power supply, a socket to receive a plug connected to a mains power supply, or wires to be connected by an electrician to a mains power supply.

The smoke alarm 100 also includes a Long-Life Battery 130. The Long-Life Battery 130 is sealed to prevent tampering and ensure the integrity of the smoke alarm 100. In some embodiments, the Long-Life Battery 130 is located in a sealed compartment of a housing of the smoke alarm 100. In some embodiments, the Long-Life Battery 130 is sealed during manufacture as a result of a cover being attached to the housing, wherein the cover is not designed to be removed from the housing. In some implementations, the cover is secured to the housing using engaging clips, lugs, threads, fasteners, adhesive, or any combination thereof. The fasteners may include, for example, screws, such as Phillips screws, Torx screws, or anti-tamper screws. The Long-Life Battery 130 may be implemented using any suitable battery that can power the smoke alarm 100 for 10 years. Suitable batteries include, for example, lithium batteries.

Each of the Mains Power Input Circuitry 110 and the Long-Life Battery 130 is connected to a Power Source Selector 120, which controls whether or not the Long-Life Battery 120 is used to power the smoke alarm 100, based on whether or not mains power is connected to the Mains Power Input Circuitry 110. In one implementation, the Power Source Selector 120 utilises a fixed voltage regulator that outputs 3.3V when mains power is connected to the Mains Power Input Circuitry 110 and 0V when mains power is not connected to the Mains Power Input Circuitry 110.

The Power Source Selector 120 also utilises a diode to which the Long-Life Battery 130 is coupled. The output of the Long-Life Battery 120 is 3V and is fed through the diode. When mains power is coupled to the Mains Power Input Circuitry 110, mains power is reduced to 12V, fed through a safety gauge capacitor C2 and regulator ZD2 and presented to the fixed voltage regulator U1 that outputs 3.3V. As 3.3V is greater than the 3V output by the Long-Life Battery 120, the diode is reverse biased during the presence of the mains power and consequently power flows from the mains power, via the Mains Power Input Circuitry 110, rather than from the Long-Life Battery 120. Conversely, when there is no mains power coupled to the Mains Power Input Circuitry 110, the fixed voltage regulator outputs 0V, resulting in the diode being forward biased and current flowing from the Long-Life Battery 130 via the fuse F1 and switch diode D6.

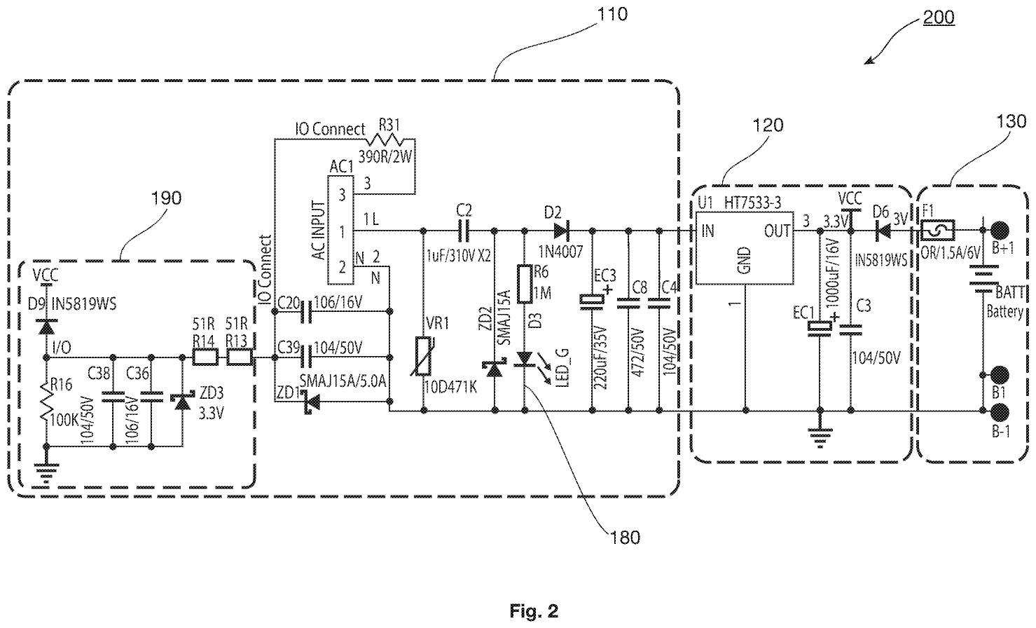

The use of a Power Source Selector 120 of the type shown in FIG. 2 is in contrast to circuitry of existing mains powered smoke alarms with short-life backup batteries, in which the mains power is connected in parallel to the short-life backup battery and thus the mains power can be used to charge the backup battery. The diode D6 of the Power Source Selector 120 of FIG. 2 prevents the mains power from charging the Long-Life Battery 120, whilst allowing the Long-Life Battery 120 to power the smoke detector 200 when mains power is not present.

The smoke alarm 100 further includes a microcontroller 150, a buzzer 140, and a smoke detector 160. The power output from the Power Source Selector 120 is provided to the microcontroller 150. The smoke detector 160 detects the presence of smoke and, in doing so, activates the microcontroller 150. Upon activation by the smoke detector 160, the microcontroller 150 activates the buzzer 140 to issue an audible alert. Depending on the implementation, the microcontroller may also issue a visual alert, such as activating a light. The light may be, for example, a light emitting diode (LED).

The smoke detector 160 may be implemented using an ionization smoke detector that utilises a small amount of radioactive material placed between two electrically charged capacitive plates. The radioactive material ionizes the air between the plates, enabling current to flow between the two plates. When there is smoke present, smoke disrupts the flow of ionised air between the plates, causing a reduction or interruption of current flow between the plates, thus triggering the alarm.

In an alternative arrangement, the smoke detector 160 is implemented using a photoelectric smoke detector that utilise a light source directed away from a sensor within a detection chamber. When there is smoke present, the light scatters on impact with the smoke particles, which results in light impacting on the sensor that then triggers the alarm.

In a further alternative arrangement, the smoke detector 160 utilises a combination of both ionization and photoelectric smoke detectors. Whilst such a combination requires more space within the smoke alarm 100 and incurs additional cost, the combination of ionization and photoelectric smoke detectors provides a higher level of protection, as ionization smoke detectors are generally more responsive to flaming fires and photoelectric smoke detectors are generally more responsive to smouldering fires.

The smoke alarm 100 in the example of FIG. 1 optionally includes a radio frequency (RF) module 170 that is coupled to the microcontroller 150. The RF module 170 is utilised to send wireless radiofrequency signals to RF modules on other smoke alarms, thus providing a network of smoke alarms. When any one of the smoke alarms is activated by the associated smoke detector detecting the presence of smoke, the RF module sends a wireless alert signal to activate the other smoke alarms. Operating a network of smoke alarms provides a safer environment by alerting any occupants within range of any of the smoke alarms, not only the smoke alarm that performs the initial detection of smoke. Consequently, occupants may be given more time to react to the presence of smoke.

The smoke alarm 100 optionally includes connection circuitry 190 for coupling the smoke alarm 100 to remote smoke alarms using a wired connection. As described above with reference to the RF module 170, the connection circuitry 190 enables smoke alarms to communicate with each other to trigger connected alarms and thus provide early warning to a broader area.

FIG. 2 is a circuit diagram 200 of one embodiment of a smoke alarm with dual primary power sources. The circuit diagram 200 includes each of the Mains Power Input Circuitry 110, the Power Source Selector 120, and the Sealed Long-Life Battery 130.

The Mains Power Input Circuitry 110 includes a coupling AC1 to which mains power can be connected. The coupling AC1 includes pin 1 for connecting a live wire, pin 2 for connecting a neutral wire, and pin 3 for wired interconnectivity to a remote smoke alarm. In the example of FIG. 2, the smoke alarm 100 includes connection circuitry 190 to enable the smoke alarm to be coupled to other smoke alarms. The connection circuitry 190 is coupled to the I/O Connect point on the circuit and enables other smoke alarms to be physically coupled to the smoke alarm of FIG. 2 through a wired connection. Physically connecting smoke alarms to each other enables a single smoke alarm to trigger other smoke alarms, thus issuing a warning over a greater area.

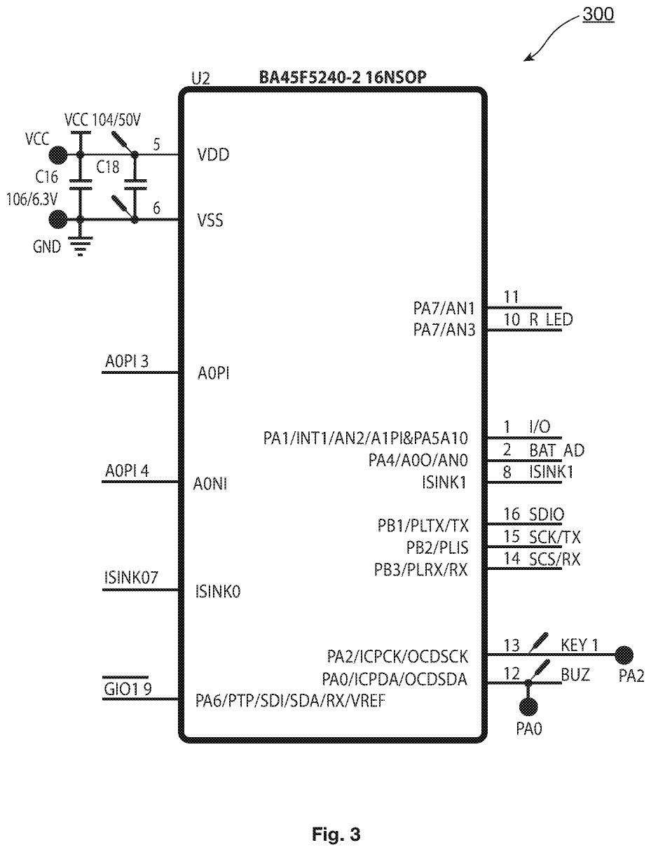

The connection circuitry 190 is coupled to the I/O Connect point, which in turn connects to pin 3 of AC1. When a remote smoke alarm that is physically connected to the connection circuitry 190 detects the presence of smoke and activates, that remote smoke alarm sends 3V to the I/O Connect point and then to pin 3 of AC1. The I/O Connect point also couples to the I/O pin of a microcontroller, an example of which is discussed below with reference to FIG. 3, to activate a buzzer for the local smoke alarm. Conversely, when the smoke alarm implemented using the circuitry 200 of FIG. 2 detects the presence of smoke, pin 3 of AC1 will send a 3V activation signal via the I/O Connect point to any remote smoke alarm physically connected to that connection circuitry in order to activate those remote smoke alarms.

The Power Source Selector 120 is implemented using a fixed voltage regulator in the form of integrated circuit HT7533-3 manufactured by Holtek Semiconductor Inc. As described above in relation to FIG. 1, the integrated circuit HT7533-3 receives as an input any voltage applied to the Mains Power Input Circuitry 110. If mains power is coupled to the Mains Power Input Circuitry 110, then HT7533-3 outputs +3.3V. If mains power is not coupled to the Mains Power Input Circuitry 110, then HT7533-3 outputs 0V. The output from the Long-Life Battery 130 is presented to a diode, labelled D6, via a fuse F1. If HT7533-3 outputs 3.3V, then the diode is reverse biased and no current flows from the Long-Life Battery 130. If HT7533-3 outputs 0V, then current flows from the Long-Life Battery 130. Thus, VCC is either 3V, when powered by the Long-Life Battery 130 in the absence of a connection to mains power, or 3.3V, when powered by mains power coupled to the Mains Power Input Circuitry 110.

FIG. 3 is a pinout diagram of a microcontroller 300 suitable for use in the circuit 200 of FIG. 2. In the example of FIG. 3, the microcontroller 300 is implemented using an integrated circuit BA45F5240-2 16NSOP, which is a smoke detector flash microcontroller unit produced by Holtek Semiconductor Inc. The microcontroller 300 couples to the circuit 200 of FIG. 2 in accordance with the labels on the pins of the microcontroller 300. Table 1 shows the connections to the pins of the microcontroller 300.

TABLE 1

| Pin | Connection |
|---|---|
| 1 | I/O |
| 2 | BAT AD |
| 3 | A0PI |
| 4 | A0NI |
| 5 | VCC |
| 6 | VSS |
| 7 | ISINK0 |
| 8 | ISINK1 |
| 9 | GIO1 |
| 10 | R LED |
| 11 | — |
| 12 | BUZ |
| 13 | KEY |
| 14 | SCS/RX |
| 15 | SCK/TX |
| 16 | SDIO |

In the various circuit diagrams shown in the attached documents, points marked with circles, such as B+1, B1, B−1, VCC, GND, PA0, PA2, BI_P1, and BI_N1, are all pads for testing and programming. As such, those pads are optional and do no serve any purpose during operation of the smoke alarm 100.

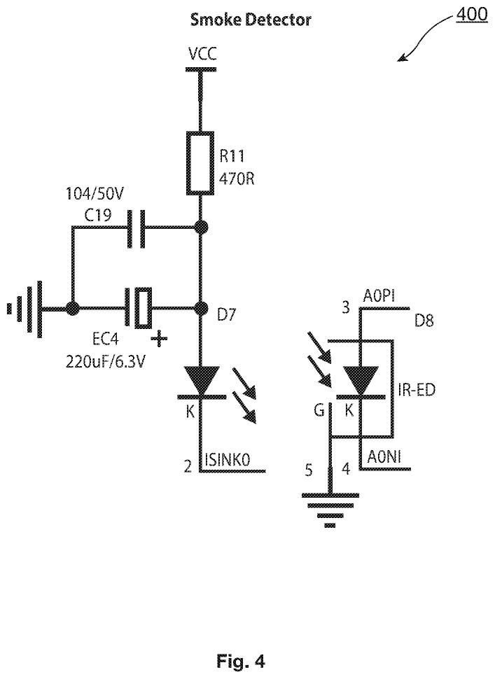

FIG. 4 is a pinout diagram of a smoke detector 400 suitable for use in the circuit 200 of FIG. 2. The smoke detector 400 includes a photoelectric detector that utilises an infrared emitting diode D7 and an infrared receiving tube D8 that is connected to pins 3 (A0PI) and 4 (A0NI) of the microcontroller 300 of FIG. 3. In the absence of smoke, the receiving tube D8 receives a strong signal from D7. When smoke is present, smoke interferes with the transmission of the infrared signal from D7 to D8. The microcontroller 300 includes an internal analog to digital (A/D) converter that processes the received signal from D8 and detects the presence of smoke when the received signal at D8 is below a predefined threshold. On detecting the presence of smoke, the controller 300 activates the buzzer connected to pin 12 and the red LED connected to pin 10.

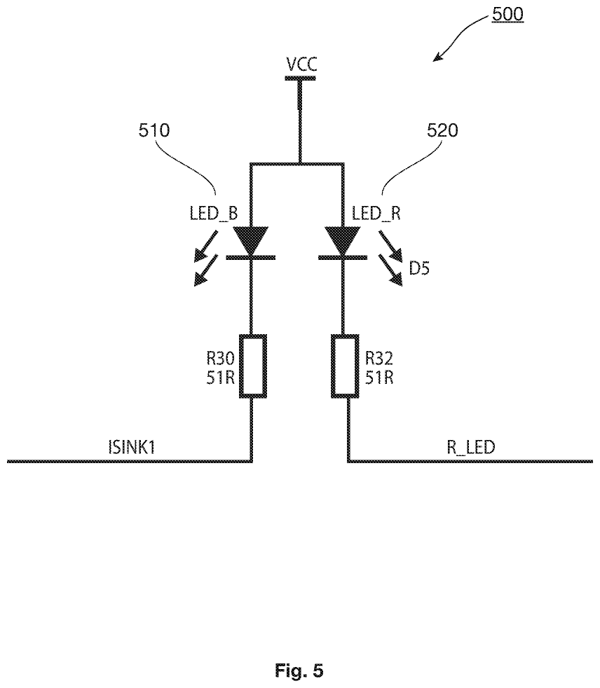

FIG. 5 is a circuit diagram of circuitry for illuminating different visual indicators to provide a user with an indication of the power state of a smoke alarm having two primary power sources. In the example of FIG. 5, the smoke alarm is equipped with a set of visual indicators in the form of a blue LED 510, a red LED 520, and a green LED 180 in the main circuit of FIG. 1. Various combinations of the visual indicators can be activated to denote different states of the alarm. In particular, the different visual indicators may illuminate in accordance with respective predefined flash sequences. A predefined flash sequence may include being permanently on, permanently off, periodically illuminating at a predefined frequency, or periodically illuminating in accordance with a predefined sequence of on and off flashes.

In one embodiment, states of the smoke alarm are as denoted in Table 2 below.

TABLE 2

| Smoke Alarm Status | Indicator light |
|---|---|
| Ac Power and Stand By | Green light stays on |
| | Red light flashes periodically (e.g., once 48 seconds) |
| AC power and Alarm Triggering | Green light stays on |
| | Red light flashes once periodically (e.g., every 1 sec) with |
| | Alarm beep |
| Ac power, False alarm | Green light keeps on |
| | Alarm beeps once periodically (e.g., every 48 seconds) |
| AC power, Low battery of Alarm | Green light keeps on |
| | Blue light flashes periodically (e.g., once every 48 seconds) |
| Battery power, stand by | Blue light flashes periodically (e.g., once every 48 seconds) |
| Battery power, Alarm trigger | Blue light flashes periodically (e.g., once every 48 seconds) |
| | Red light flashes periodically (e.g., once every 1 second) |
| | with corresponding audible beeps |
| Battery power, low Battery | Blue light flashes periodically (e.g., once every 48 seconds) |
| | with corresponding audible beep |
| Battery power, false alarm | Alarm beeps periodically (e.g., once every 48 seconds) |
| | without blue light |

In the example of FIG. 5, when the smoke detector detects the presence of smoke, then the smoke alarm is triggered (i.e., “activated”). Upon being triggered, the smoke alarm issues a visual and audible alert. The visual and audible alerts may be customised for particular applications. However, there are various standards for audible and visual alarms.

In some embodiments, the smoke alarm is configured to operate in accordance with the standard defined by ISO 8201. In such embodiments, the triggered smoke alarm issues visual and audible alerts that follow a sequence defined by ISO8201, wherein a buzzer within the smoke alarm plays a repeating sequence of three 500 ms audible tones, separated by 500 ms, followed by a 1.5 s silence. Each tone is accompanied by flashing of the red LED 520. In the example of FIG. 5, the red LED 520 flashes for 5 ms per 50 seconds during normal operation, when the smoke alarm has not been activated, to indicate that the smoke alarm is operating on mains power but without being too distracting to occupants. It will be appreciated that other frequency and duration cycles may equally be practised, depending on the implementation.

In some scenarios, smoke alarms within a premises are coupled to one another. The coupling among smoke alarms may be implemented using wired connections, wireless connections, or a combination thereof. For example, some smoke alarms are equipped with a radio frequency (RF) module for wireless communication with other, similarly-equipped smoke alarms. When a first smoke alarm detects the presence of smoke and is activated, that first smoke alarm sends a trigger signal to other smoke alarms to which it is coupled. Those other smoke alarms also issue the same audible alert as issued by the first smoke alarm, but do not activate the red LEDs to flash. Thus, occupants receive an audible alert regarding the presence of smoke and the presence or absence of a flashing red LED provides an indication of the location at which smoke was detected.

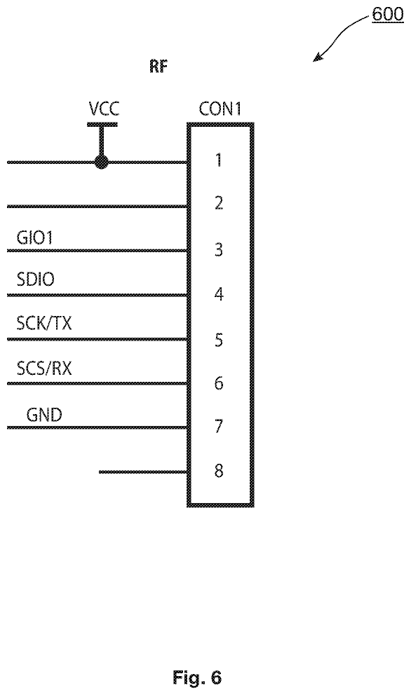

FIG. 6 is a pinout diagram of an RF transceiver integrated circuit 600 suitable for use with the circuit 200 of FIG. 2 to implement the RF module 170 of FIG. 1. In the example of FIG. 6, the RF integrated circuit 600 is implemented using the BC3602 Sub-1 GHx Low RX Current FSK/GFSK RF Transceiver manufactured by Holtek. The RF transceiver IC 600 can be utilised to couple the smoke alarm 100 to other smoke alarms also equipped with a suitable RF transceiver.

In some embodiments, the RF integrated circuit 600 includes pairing functionality that enables a first smoke alarm to pair wirelessly with one or more other remote smoke alarms. During a pairing operation, one smoke alarm sends a wireless transmission that includes a unique identifier of the transmitting smoke alarm to a receiving smoke alarm that responds by transmitting its own unique identifier. Smoke alarms that have been paired are able to send and receive data from one another. When pairing smoke alarms to each other, the smoke alarm optionally flashes one or more lights, such as LEDs, in a predefined manner to indicate that pairing is underway and to confirm that pairing has successfully completed. In some embodiments, the RF circuit 600 transmits a unique identifier associated with the smoke alarm in which the RF circuit 600 is installed and smoke alarms that receive an RF transmission only act on messages that include the identifier of a smoke alarm with which those smoke alarms have been paired. As described herein, smoke alarms coupled with each other, either via a wired connection or a wireless connection, can be utilised to provide broader protection by alerting occupants in locations not proximal to where smoke is initially detected. Early warnings are vital to minimise harm to people and belongings.

The RF integrated circuit 600 has 8 pins, with connectivity as shown with reference to the circuitry 200 of FIG. 2 and the microcontroller 300 of FIG. 3. The RF integrated circuit 600 of FIG. 6 utilises the serial peripheral interface (SPI) interface bus to send and receive data between the smoke alarm and other remote smoke alarms with which the smoke alarm is paired. In particular, pin 1 connects to VCC, pin 3 is a GIO general input/output pin coupled to pin 9 of the microcontroller 300, pin 4 is SDIO coupled to pin 16 of the microcontroller 300, pin 5 is SCK/TX and is coupled to pin 15 of the microcontroller 300, pin 6 is SCS/RX and is coupled to pin 14 of the microcontroller 300, and pin 7 is connected to ground.

The microcontroller 300 instructs the RF integrated circuit 600 to send an RF signal by utilising the SPI communication pins (SCS, SCK, SDIO), upon detection of smoke and the chip 600, on receipt of an RF signal, sends a trigger signal to the GIO1 PIN of the microcontroller 300 to issue an audible alert by activating the buzzer, but without activating the flash.

Whilst the circuitry 200 of FIG. 2 does not show the RF module 170, the RF module 170 can be readily connected to the circuitry 200. In some implementations, the circuitry 200 includes a coupling to enable a RF module 170, such as implemented using the RF integrated circuit 600, to be readily coupled to the circuitry 200 such that the pins of the RF integrated circuit 600 are connected to the correct pins of the microcontroller 300. Providing such a coupling enables the RF module 170 to be supplied as an optional module and readily coupled to the circuitry 200. The coupling may be implemented in many different ways. For example, the coupling may be a female coupling for receiving a corresponding male portion of the RF module 170. Conversely, the coupling may be a male coupling for receiving a corresponding female portion of the RF module 170.

In some embodiments, the smoke alarm with dual power sources includes both the connection circuitry 190 for effecting wired connections to remote smoke alarms and the RF module 170 for wireless connection to other smoke alarms. In other embodiments, the RF module 170 replaces the connection circuitry 190, so that the smoke alarm has wireless connectivity, but is not configured for wired connectivity to other smoke alarms. In yet other embodiments, the smoke alarm includes only the connection circuitry 190 for effecting wired connections to other smoke alarms.

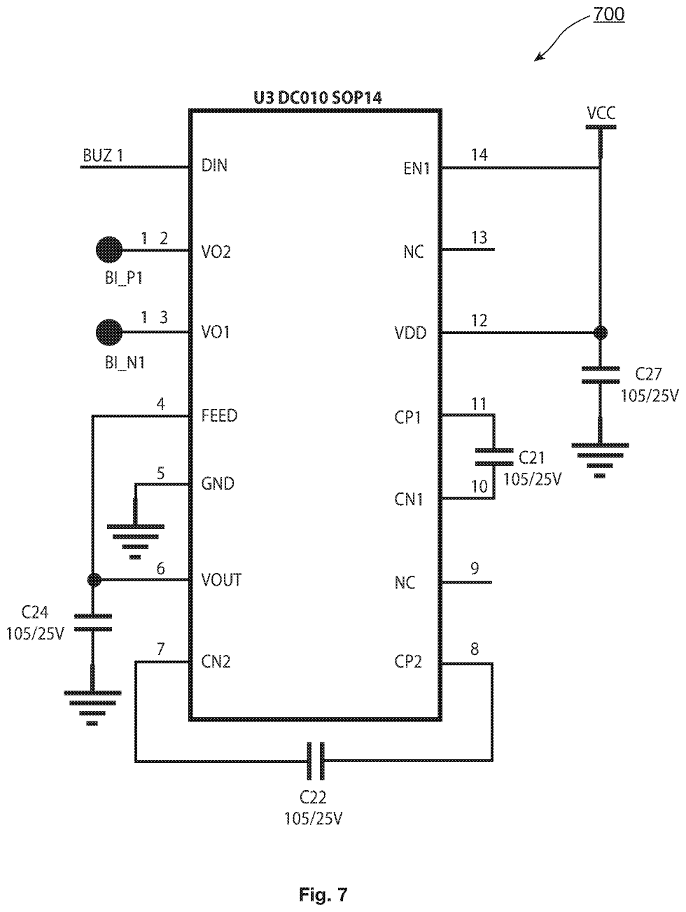

FIG. 7 is a pinout diagram of a buzzer booster 700 that is coupled to pin 12 of the microcontroller 300 of FIG. 3. In the example of FIG. 7, the buzz booster integrated circuit is implemented using DC010 SOP14 manufactured by DONG CUN Electronics Co. Ltd. When the microcontroller 300 is activated by the smoke detector 400 triggering pin 3 of the microcontroller 300, the output pin 12 of microcontroller 300 goes high, activating pin 1 of the buzzer booster 700 to which pin 12 of microcontroller 300 is connected. When the buzzer booster 700 is activated, the buzzer booster 700 emits an audible alert signal. In the example of FIG. 3, the microcontroller 300 is programmed to output a frequency on pin 12 to be used by the buzzer booster 700. Depending on the implementation of the microcontroller the frequency may be changed by different firmware, such as by flashing an EPROM. It will be appreciated that the output frequency may be changed by additional circuitry, not shown, to customise the frequency for particular applications.

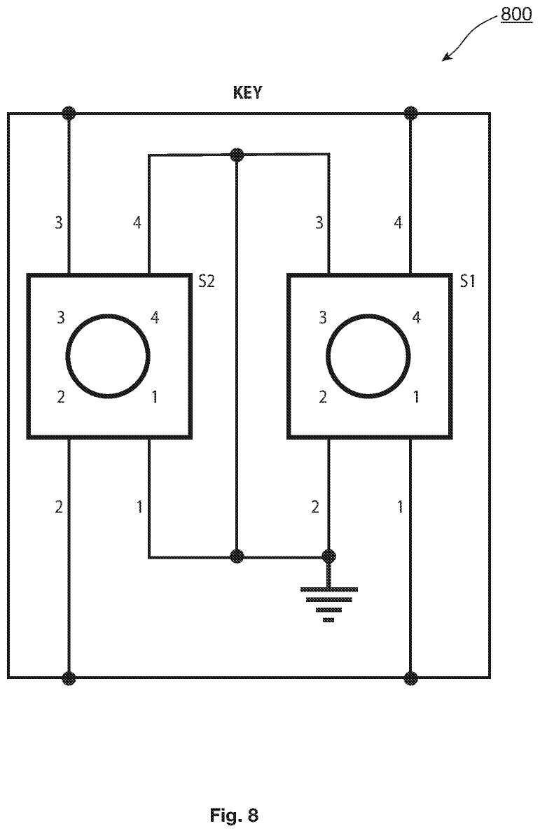

FIG. 8 is a key 800 for the circuit 200 of FIG. 2. The key 800 provides a test button by which to test the key circuit low voltage (0V). When the button of the key 800 is pressed, a test alarm is activated. The Key node on the circuit 800 is coupled to pin 13 of the microcontroller 300 and enables a user to test the functionality of the smoke alarm. When a user depresses either switch S1 or switch S2, pin 13 is brought to ground, activating the buzzer of the microcontroller 300 to confirm that the smoke alarm is functioning correctly. The button can be depressed again to toggle the alarm off. In a simpler implementation, as single toggle switch may be utilised in the place of switch S1 and switch S2.

### INDUSTRIAL APPLICABILITY

The arrangements described are applicable to the electrical and safety industries.

Although the invention has been described with reference to specific examples, it will be appreciated by those skilled in the art that the invention may be embodied in many other forms. The foregoing describes only some embodiments of the present invention, and modifications and/or changes can be made thereto without departing from the scope and spirit of the invention, the embodiments being illustrative and not restrictive.

In the context of this specification, the word “comprising” and its associated grammatical constructions mean “including principally but not necessarily solely” or “having” or “including”, and not “consisting only of”. Variations of the word “comprising”, such as “comprise” and “comprises” have correspondingly varied meanings.

As used throughout this specification, unless otherwise specified, the use of ordinal adjectives “first”, “second”, “third”, “fourth”, etc., to describe common or related objects, indicates that reference is being made to different instances of those common or related objects, and is not intended to imply that the objects so described must be provided or positioned in a given order or sequence, either temporally, spatially, in ranking, or in any other manner.

Reference throughout this specification to “one embodiment,” “an embodiment,” “some embodiments,” or “embodiments” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

While some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practised without these specific details. In other instances, well-known methods, structures and techniques have not been shown in detail in order not to obscure an understanding of this description.

Note that when a method is described that includes several elements, e.g., several steps, no ordering of such elements, e.g., of such steps is implied, unless specifically stated.

The term “coupled” should not be interpreted as being limitative to direct connections only. The terms “coupled” and “connected,” along with their derivatives, may be used. It should be understood that these terms are not intended as synonyms for each other, but may be. Thus, the scope of the expression “a device A coupled to a device B” should not be limited to devices or systems wherein an input or output of device A is directly connected to an output or input of device B. It means that there exists a path between device A and device B which may be a path including other devices or means in between. Furthermore, “coupled to” does not imply direction. Hence, the expression “a device A is coupled to a device B” may be synonymous with the expression “a device B is coupled to a device A”. “Coupled” may mean that two or more elements are either in direct physical or electrical contact, or that two or more elements are not in direct contact with each other but yet still co-operate or interact with each other.

1. A smoke detector having connectivity for dual primary power sources, the smoke detector comprising:
mains power connectivity adapted to couple to a mains power supply;
a long-life battery located in a sealed compartment;
a microcontroller;
a smoke detector coupled to said microcontroller so as to generate a trigger when said smoke detector detects smoke;
a power source selector for selecting between mains power supply and said long-life battery to power said microcontroller, based on the presence of said mains power supply; and
a buzzer for issuing an audible alert when said microcontroller is triggered by said smoke detector detecting the presence of smoke.

2. The smoke detector of claim 1, wherein said smoke detector is at least one of an ionization smoke detector and a photoelectric smoke detector.

3. The smoke detector of claim 1, further comprising:
a first light associated with said mains power connectivity; and
a second light associated with said long-life battery;
wherein said first light illuminates when said smoke detector is coupled to mains power, and
wherein said second light illuminates when said smoke detector is powered by said long-life battery and is not coupled to mains power.

4. The smoke detector of claim 3, wherein said first and second lights are light emitting diodes (LEDs).

5. The smoke detector of claim 3, wherein said first light and said second light are different colours.

6. The smoke detector of claim 3, wherein said first light illuminates in accordance with a predefined flash sequence.

7. The smoke detector of claim 3, wherein said second light illuminates in accordance with a predefined flash sequence.

8. The smoke detector of claim 1, wherein said long-life battery is a lithium battery.

9. The smoke detector of claim 1, said smoke detector further comprising:
a housing that defines a compartment within which said long-life battery is positioned, wherein said compartment is covered by a cover to form said sealed compartment.

10. The smoke detector of claim 9, wherein said cover is secured to said housing using at least one of: engaging clips, lugs, threads, fasteners, and adhesive.

11. The smoke detector of claim 1, wherein said power source selector includes a fixed voltage regulator that outputs:
a higher voltage than said long-life battery when mains power is coupled to said mains power connectivity; and
zero voltage when mains power is not coupled to said mains power connectivity.

12. The smoke detector of claim 11, wherein said power source selector further includes a reverse biased diode to prevent current flow from said long-life battery when mains power is coupled to said smoke detector.

13. The smoke detector of claim 1, further comprising:
a radio frequency (RF) module coupled to said microcontroller, wherein said RF module is configured to transmit a wireless radiofrequency signal when said microcontroller is triggered by said smoke detector.

14. The smoke detector of claim 1, further comprising:
connection circuitry for coupling said smoke detector to a remote smoke alarm, wherein said smoke detector sends an activation signal through said connection circuitry to said remote smoke alarm when said smoke detector generates a trigger upon detecting smoke.

15. The smoke detector of claim 1, wherein said microcontroller outputs a predefined buzzer frequency to said buzzer, when said microcontroller is triggered by said smoke detector.

16. The smoke detector of claim 1, further comprising:
a third light that illuminates when said microcontroller is triggered by said smoke detector detecting the presence of smoke.

17. The smoke detector of claim 16, wherein said third light is a red LED that illuminates by flashing periodically in accordance with a predefined frequency.
